(19) United States
(12) Patent Application Publication
(10) Pub. No.: US 2014/0297983 A1
(43) Pub. Date: Oct. 2, 2014

(54) METHOD OF ARRANGING DATA, INFORMATION PROCESSING APPARATUS, AND RECORDING MEDIUM

(71) Applicant: FUJITSU LIMITED, Kawasaki-shi (JP)

(72) Inventors: Hideyuki Takeda, Numazu (JP); Kazuyoshi Watanabe, Kannami (JP)

(73) Assignee: FUJITSU LIMITED, Kawasaki-shi (JP)

(21) Appl. No.: 14/219,085

(22) Filed: Mar. 19, 2014

(30) Foreign Application Priority Data
Mar. 29, 2013 (JP) 2013-075027

(51) Int. Cl. G06F 3/06

(52) U.S. Cl. CPC G06F 3/0647; G06F 3/0604; G06F 3/0673
USPC 711/165

(57) ABSTRACT

A method of arranging data in a stratified storage region includes: acquiring an index value related to data stored in the stratified storage region based on a predetermined rearrangement condition; and determining, based on the index value, data to be migrated from the data stored in the stratified storage region.

### CROSS-REFERENCE TO RELATED APPLICATION

This application is based upon and claims the benefit of priority of the prior Japanese Patent Application No. 2013-075027, filed on Mar. 29, 2013, the entire contents of which are incorporated herein by reference.

### FIELD

The embodiments discussed herein are related to a method of arranging data, an information processing apparatus, and a recording medium.

### BACKGROUND

Japanese Laid-Open Patent Publication No. 2010-257094 is known as an example of related art. Access frequency per unit of time is observed for each data in data stored in a hierarchized storage device having disk devices with different access speeds according to the related art. The data is migrated to a high-speed disk when the access frequency exceeds a predetermined value.

### SUMMARY

According to an aspect of the invention, a method of arranging data in a stratified storage region includes: acquiring an index value related to data stored in the stratified storage region based on a predetermined rearrangement condition; and determining, based on the index value, data to be migrated from the data stored in the stratified storage region.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example configuration of a storage system according to a first embodiment;

FIG. 2 is an example configuration of a storage system according to a second embodiment;

FIG. 3 is an example of hardware that enables data arrangement processing;

FIG. 4 is a flow chart representing an example of data arrangement processing;

FIG. 5 is a flow chart representing an example of rearrangement processing;

FIG. 6 is a flow chart representing an example of new creation processing;

FIG. 7 is a flow chart representing an example of virtual tier creation processing;

FIG. 8 is an example of a physical tier table;

FIG. 9 is an example of a virtual tier table;

FIG. 10 is a flow chart representing an example of data allocation processing for allocation to a real virtual arrangement;

FIG. 11 illustrates an example of data allocation processing for allocation to an ideal virtual arrangement;

FIG. 12 is a flow chart representing an example of a determination method for a temporary virtual arrangement;

FIG. 13A is an example of a real virtual arrangement table;

FIG. 13B is an example of an ideal virtual arrangement table;

FIG. 14 is an example of a temporary virtual arrangement table;

FIG. 15 illustrates detailed examples of virtual arrangements;

FIG. 16 is a flow chart representing an example of check processing to check data capacity;

FIG. 17 illustrates a flow chart representing an example of capacity overflow erasing processing;

FIG. 18 illustrates a flow chart representing an example of capacity overflow erasing processing;

FIG. 19 is a view for describing capacity overflow erasing processing;

FIG. 20 is a flow chart representing an example of determination processing for determining migration data; and

FIG. 21 is an example of a migration list.

### DESCRIPTION OF EMBODIMENTS

In the related art, frequent migration of data, for example, that is frequently rearranged between high-speed disks and low-speed disks may occur regardless of whether or not the actual desired access speed (accessibility) of the data changes. Consequently, the load on data migration processing may be increased.

The following is a detailed explanation of embodiments with reference to the accompanying drawings. While a storage system is described as an example of a system configuration for performing data rearrangement in the following description, the embodiments discussed herein are not limited as such.

### First Embodiment

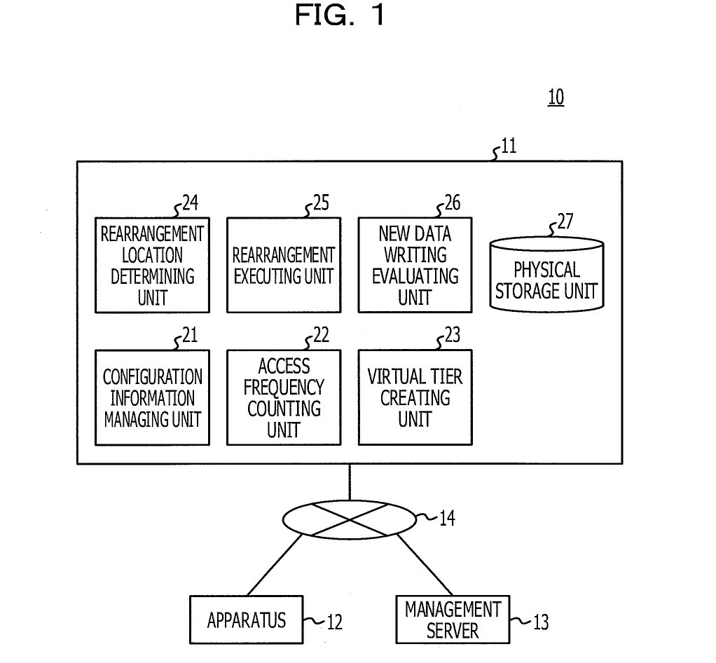

FIG. 1 is an example configuration of a storage system according to the first embodiment. A storage system 10 illustrated in FIG. 1 has a storage device 11 as an example of an information processing apparatus, an apparatus 12, and a management server 13. The storage device, the apparatus 12, and the management server 13 are coupled in a manner that allows for the transmission and reception of data over a communication network 14 represented by, for example, the Internet or a local area network (LAN).

The storage device 11 provides certain services and stores various types of data used for implementing work. The storage device 11 realizes efficient data arrangement through, for example, automatic stratification, and arranges the data in a relative manner and not in an absolute manner. The storage device 11 also effectively uses high tiers and high-speed storage, for example, so that data with a low migration effect is not migrated using virtual tiers.

The apparatus 12 is used by a user who selectively uses various types of data stored in the storage device 11 as desired. The apparatus 12 transmits commands for data requests and the like to the management server 13 and the storage device 11, and receives the corresponding data.

The management server 13 is an apparatus used by a manager for managing data access and the like to the storage device 11 and managing usage histories and the like of the data of each of the apparatuses 12.

The apparatus 12 and the management server 13 are, but are not limited to, a personal computer (PC) or a tablet and the like.

The following explanation describes an example of a detailed functional configuration of the storage device 11. The storage device 11 has a configuration information management unit 21, an access frequency counting unit 22 as an example of a calculating unit, a virtual tier creating unit 23, a rearrangement location determining unit 24 as an example of a determining unit, a rearrangement executing unit 25, a new data writing evaluating unit 26, and a physical storage unit 27.

The configuration information management unit 21 manages configuration information inside the physical storage unit 27. In the present embodiment, the configuration information includes, for example, the number of physical tiers and information about storage capacity and available capacity in each physical tier and the like. However, the type of information included in the configuration information is not limited as such and may also include, for example, information on accessibility such as access (input/output) speeds and the like. The physical tiers may be, without being limited to, a plurality of disks stratified in order of access speed based on the types of disks having different access speeds. The configuration information management unit 21 is able to learn the entire capacity of the physical tiers by allocating the physical tiers into disks. The configuration information management unit 21 is also able to manage, for example, data management information such as the time and date of the last update and access frequency per unit of time for each piece of data.

The configuration information management unit 21 also manages whether or not the configuration information in the physical storage unit 27 has been updated and updates the management information if the configuration information has been changed. In the present embodiment, the configuration information management unit 21 conducts, without being limited to, the updating of the management information when, for example, starting up or when disks are added or exchanged.

The access frequency counting unit 22 counts the number of accesses (frequency) when an access to data in the physical storage unit 27 occurs. While the access frequency counting unit 22 is able to, but is not limited to, count the number of accesses per accessed data, the access frequency counting unit 22 may also count the number of accesses per disk in the physical storage unit 27 for example. The access frequency counting unit 22 is able to, but is not limited to, acquire the access frequency (e.g., average number of accesses per unit of time) and the like. The counted number of accesses is managed by, for example, the configuration information management unit 21.

The access frequency counting unit 22 may also, without being limited to, count the time from the latest access or the utilization rate of the highest tier (highest position).

The virtual tier creating unit 23 creates a virtual tier corresponding to a physical tier in the physical storage unit 27 for determining rearrangement locations. Through the use of the virtual tier created by the virtual tier creating unit 23, the cost of migrating data is quantified so that data with a high migration effect is migrated while the migration of data with a low migration effect is canceled in the present embodiment. As a result, a reduction in accessibility is reduced due to a decrease in wasteful migration (input/output) between disks.

The virtual tier creating unit 23 previously secures available capacity in a portion or in all of the tiers before creating the virtual tier. As a result, accessibility to new data becomes very high since the new data is written in the upper tier due to, for example, the creation of available regions having a certain capacity in the upper tier.

The rearrangement location determining unit 24 uses the virtual tier regions created by the virtual tier creating unit 23 when determining the rearrangement locations for the data. The rearrangement location determining unit 24 allocates data to a real virtual tier corresponding to the actual arrangement of data, and allocates data to an ideal virtual tier corresponding to an ideal arrangement in accordance with a previously set rearrangement condition.

The rearrangement condition may be, but is not limited to, a condition of whether or not an access frequency to data exceeds a certain threshold, for example. The rearrangement condition may be, for example, a condition of whether or not the time from the last rearrangement exceeds a certain threshold or whether or not the utilization rate of the highest tier (highest position) exceeds a certain threshold, or the rearrangement condition may be a combination of the two conditions.

The rearrangement location determining unit 24 compares the data arrangement in the real virtual tier with the data arrangement in the ideal virtual tier to acquire an index value corresponding to the data, and then determines whether or not to migrate the data based on the acquired index value. The rearrangement location determining unit 24 determines a temporary virtual arrangement based on the possibility of the determined migration of the data. An example of the index value is a migration width between, for example, the data arrangement in the real virtual tier and the data arrangement in the ideal virtual tier. The rearrangement location determining unit 24 determines a temporary virtual arrangement based on the acquired migration width and the predetermined threshold.

The rearrangement location determining unit 24 may also check the data capacity of the temporary virtual arrangement and may erase a capacity overflow as occasion calls. The rearrangement location determining unit 24 outputs the finally adjusted migration data to the rearrangement executing unit 25.

The rearrangement executing unit 25 executes rearrangements by migrating data based on a migration list acquired from the rearrangement location determining unit 24. Processing by the abovementioned virtual tier creating unit 23, the rearrangement location determining unit 24, and the rearrangement executing unit 25 may be executed by calling up a predetermined rearrangement method. The rearrangement method includes at least one process among processes such as, for example, “securing available regions,” “establishing high-tier priority arrangement based on a relative evaluation,” and “introducing a virtual tier.” When, for example, an unforeseen error (e.g., shortage of capacity) occurs, the rearrangement method includes performing exceptional processing such as sending an error message and the like to the apparatus 12 and/or the management server 13.

The new data writing evaluating unit 26 evaluates whether or not an access to the physical storage unit 27 from the apparatus 12 or the management server 13, for example, is a creation (writing) of new data. For example, the new data writing evaluating unit 26 writes newly created data from an upper physical tier that is an available region when the access involves the creation of new data. The new data writing evaluating unit 26 may call up a new creation method for performing the above processing and execute the method. The upper physical tier is, but is not limited to, a high tier that enables high-speed access among a plurality of disks in the physical storage unit 27 for example.

The new data writing evaluating unit 26 may determine whether or not writing of new data has occurred. When, for example, an unforeseen error (e.g., shortage of capacity) occurs in the new creation method, the new data writing evaluating unit 26 performs exceptional processing such as reporting an error message and the like to the apparatus 12 or the management server 13.

The new data writing evaluating unit 26 causes the configuration information management unit 21 to update the data management information after writing or reading of the new data. The new data writing evaluating unit 26 performs normal processing when the apparatus 12 or the management server 13 accesses the physical storage unit 27, for example, but the access does not involve the creation (writing) of new data.

The physical storage unit 27 has one or more disk devices and drive devices and these devices each have the same or different access speeds and storage capacities. The physical storage unit 27 may be, but is not limited to, a hard disk drive (HDD) or a solid state drive (SSD) and the like.

In the first embodiment, disks with high accessibility are used effectively since the data is arranged in order from the high tiers based on a relative evaluation of the data and not on an absolute evaluation of the data. As a result, access speeds throughout the entire storage device 11 are improved.

High accessibility may be realized in the first embodiment since writing may be performed in the upper tier disks that enable high-speed access when a region to which data has not yet been allocated (available region) is created in the upper tier and writing is initiated with new data during a rearrangement of the data.

### Second Embodiment

The abovementioned components (the configuration information management unit 21, the access frequency counting unit 22, the virtual tier creating unit 23, the rearrangement location determining unit 24, the rearrangement executing unit 25, and the new data writing evaluating unit 26) are provided in the storage device 11 in the abovementioned first embodiment. However, without being limited to such a system configuration, the abovementioned components may be partially or completely provided in another device such as the management server 13.

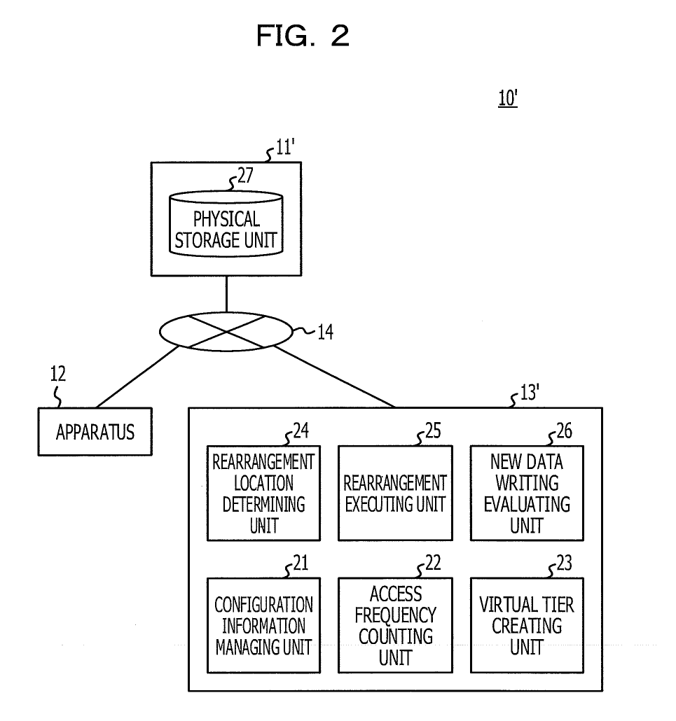

FIG. 2 is an example configuration of a storage system according to a second embodiment. Portions having the same functions as the components described in the first embodiment are provided with the same reference numerals and detailed explanations thereof will be omitted.

A storage system 10′ illustrated in FIG. 2 has a storage device 11′, the apparatus 12, and a management server 13′ as an example of an information processing apparatus. The storage device 11′, the apparatus 12, and the management server 13′ are coupled in a manner that allows for the transmission and reception of data over the communication network 14 for example.

The storage device 11′ illustrated in FIG. 2 has the physical storage unit 27. The management server 13′ has the configuration information management unit 21, the access frequency counting unit 22, the virtual tier creating unit 23, the rearrangement location determining unit 24, the rearrangement executing unit 25, and the new data writing evaluating unit 26.

While the components used for data arrangement processing are built into the storage device 11 in the abovementioned first embodiment as illustrated in FIG. 1, the abovementioned components are loaded into the management server 13′ as software in the second embodiment illustrated in FIG. 2. The management server 13′ refers to the physical storage unit 27 in the storage device 11′ through the communication network 14 to perform the data rearrangement processing in the same way as in the abovementioned first embodiment. The storage device 11 of the first embodiment and the management server 13′ of the second embodiment are both information processing apparatuses for performing the abovementioned data rearrangement processing.

(Hardware Configuration Example)

Data arrangement processing according to the present embodiment may be realized by installing an execution program (data arrangement program) that enables functions to be executed by a computer, in a general PC or server for example. The following is an explanation of a hardware configuration example of a computer that is able to realize the data arrangement processing of the information processing apparatus with reference to the drawings.

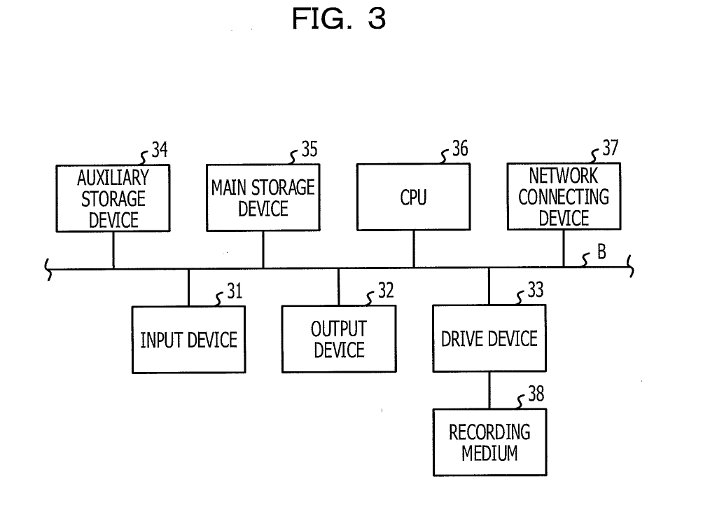

FIG. 3 is an example of hardware that enables data arrangement processing. The computer unit in FIG. 3 has an input device 31, an output device 32, a drive device 33, an auxiliary storage device 34, a main storage device 35, a central processing unit (CPU) 36 for performing various controls, and a network connecting device 37, and these components are coupled to each other via a system bus B.

The input device 31 has a keyboard and pointing device such as a mouse that are operated by the user such as a manager, and a sound input device such as a microphone. The input device 31 receives, from the user, inputs of program execution commands, various types of operating information, and information and the like for activating the software and the like.

The output device 32 has a display that displays various types of windows and data used for operating the computer unit for performing the processing of the present embodiment, and displays program execution progression and results based on control programs in the CPU 36.

The execution programs installed in the computer unit in the present embodiment are provided through a portable recording medium 38 such as a universal serial bus (USB) memory, a CD-ROM, or a DVD and the like. The recording medium 38 in which programs are recorded may be set in the drive device 33 and execution programs included in the recording medium 38 are installed in the auxiliary storage device 34 from the recording medium 38 via the drive device 33 based on control signals from the CPU 36.

The auxiliary storage device 34 is a storage such as a hard disk and stores the execution programs for the present embodiment and the control programs provided in the computer and performs input and output as desired based on control signals from the CPU 36. The auxiliary storage device 34 is able to read desired information from the stored information and write desired information based on control signals from the CPU 36.

The main storage device 35 stores execution programs and the like read from the auxiliary storage device 34 by the CPU 36. The main storage device 35 is a read-only memory (ROM) or a random access memory (RAM). The auxiliary storage device 34 and the main storage device 35 correspond to the abovementioned storage device for example.

The CPU 36 performs various types of processing by controlling processing for various calculations, the input and output of data to and from the hardware, and controls processing throughout the entire computer based on the control programs such as an operating system and the execution programs stored in the main storage device 35. Various types of information used during the execution of the programs are acquired and stored in the auxiliary storage device 34 along with the execution results.

Specifically, the CPU 36 performs processing corresponding to the programs by causing a data arrangement program installed in the auxiliary storage device 34 to be executed in the main storage device 35 based on program execution commands and the like acquired, for example, through the input device 31.

For example, the CPU 36 performs processing to manage the configuration information in the abovementioned configuration information management unit 21 and calculate the access frequency by the access frequency counting unit 22 by executing the data arrangement program. The CPU 36 performs processing such as the creation of the virtual tier by the virtual tier creating unit 23 and the determination of the rearrangement locations by the rearrangement location determining unit 24 by executing the data arrangement program. The CPU 36 performs processing such as the execution of the rearrangement by the rearrangement executing unit 25 and the writing evaluation of new data and data reading by the new data writing evaluating unit 26, by executing the data arrangement program. The processing contents of the CPU 36 are not limited to the processing described above.

The network connecting device 37 acquires execution programs, software, and setting information and the like from external apparatuses coupled to the communication network 14 based on a connection to a communication network and the like based on control signals from the CPU 36. The network connecting device 37 is able to provide execution results acquired by the execution of programs and provide the execution programs themselves to the external apparatuses.

The data arrangement processing of the present embodiment may be executed based on the abovementioned hardware. By installing the programs, the data arrangement processing of the present embodiment may be easily executed in a general PC or server.

(Example of Data Arrangement Processing)

The following is an explanation of an example of data arrangement processing in a flow chart. While data arrangement processing based on the abovementioned first embodiment is described as an example in the following explanation, the data arrangement processing may also be applicable to the second embodiment.

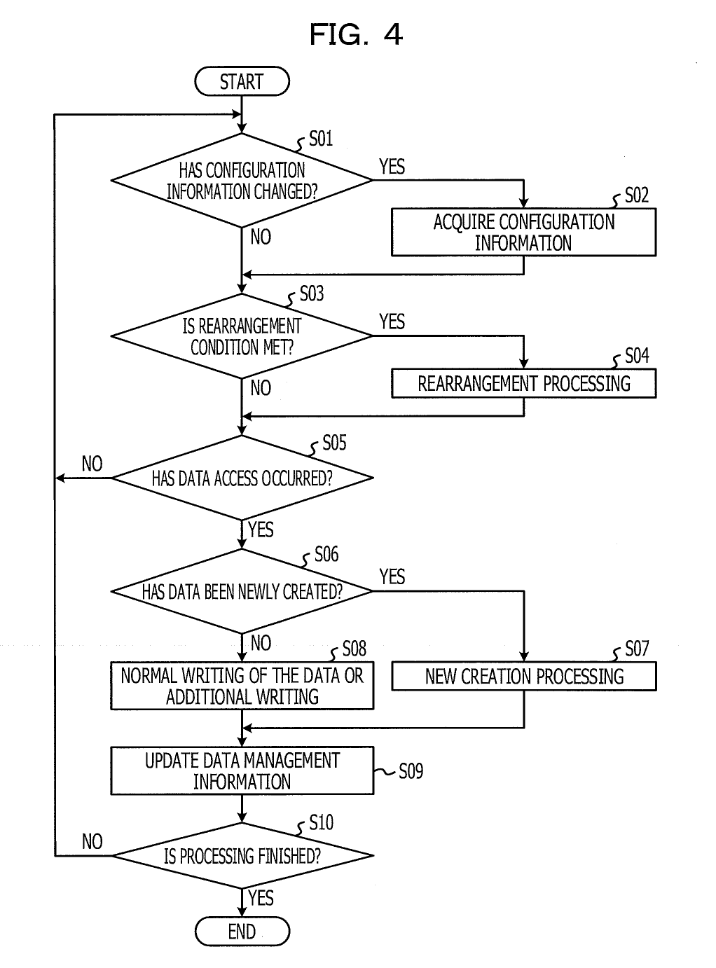

FIG. 4 is a flow chart representing an example of data arrangement processing. The configuration information management unit 21 in the example in FIG. 4 judges whether or not the configuration information in the physical storage unit 27 has changed (S01). The configuration information management unit 21 may, but is not limited to, judging the whether or not a change has occurred in the configuration information based on, for example, the presence or absence of a change in the access (input/output) speed or a change in the capacity of the physical tiers in the physical storage unit 27. The process in S01 involves judging based on an initial start-up time or a disk addition time in the physical storage unit 27, but is not limited as such.

Next, if the configuration information has been changed (S01; YES), the configuration information management unit 21 acquires the changed configuration information (S02). For example, the configuration information management unit 21 learns the entire capacity of the physical tiers and acquires the configuration information thereof by allocating physical tiers to the physical storage unit 27 based on the information of disk capacities and access speeds and the like.

If the configuration information has not been changed according to the processing in S01 (S01: NO), or after the processing of S02, the rearrangement location determining unit 24 judges whether or not a predetermined rearrangement condition is met (S03). The rearrangement condition may be whether or not, for example, the time from the last rearrangement or the utilization rate of the highest tier exceeds a certain threshold, but the rearrangement condition is not limited to being able to meet such a condition. The rearrangement condition, for example, may be a combination of a plurality of conditions among the abovementioned conditions.

If the rearrangement condition is met (S03: YES), the rearrangement executing unit 25 calls up a predetermined rearrangement method and executes the rearrangement processing (S04).

If the rearrangement condition is not met in the processing in S03 (S03: NO), or after the processing in S04 is finished, the new data writing evaluating unit 26 judges whether or not a data access has occurred (S05). If the new data writing evaluating unit 26 judges that a data access has not occurred (S05; NO), the routine returns to the processing in S01. If the new data writing evaluating unit 26 judges that a data access has occurred (s05: YES), the new data writing evaluating unit 26 judges whether or not the access involves a new creation of data (S06).

If the access is a new creation of data (S06: YES), the new data writing evaluating unit 26 calls up a predetermined new creation method and executes new creation processing (S07). If data is newly created, the processing in S07 may include writing from an upper tier disk having sufficient available capacity.

If the access is not a new creation of data (S06: NO), the new data writing evaluating unit 26 performs processing as normal to write or to additionally write the data (S08).

The configuration information management unit 21 updates the management information of the data after the processing in S07 or S08 (S09). Next, the configuration information management unit 21 judges whether or not the processing is finished (S10), and if the processing is not finished (S10: NO), the routine returns to S01. The configuration information management unit 21 finishes the data arrangement processing if the processing is finished due to a command and the like from a user (S10: YES).

When an unforeseen error such as a capacity shortage occurs, the rearrangement processing in the abovementioned S04 or the new creation processing in S07 may involve reporting the fact (exceptional processing).

(S04: Rearrangement Processing)

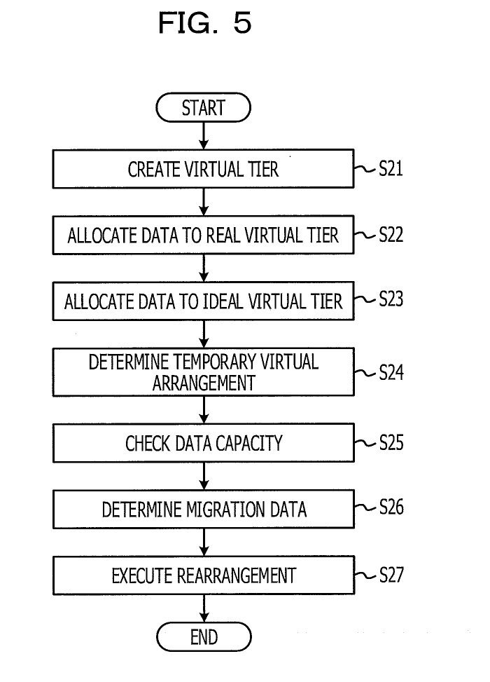

Next, the abovementioned processing (rearrangement method) in S04 will be described with reference to a flow chart. FIG. 5 is a flow chart representing an example of rearrangement processing. In the example in FIG. 5, the virtual tier creating unit 23 creates a virtual tier (S21). The virtual tier creating unit 23 in the processing in S21 previously secures available capacity in a portion or in all of the tiers before creating the virtual tier.

Next, the rearrangement location determining unit 24 allocates data to the real virtual tier corresponding to the current data arrangement (S22). The rearrangement location determining unit 24 allocates the data to the ideal virtual tier corresponding to a predetermined ideal arrangement (S23).

Next, the rearrangement location determining unit 24 compares the arrangement of the data acquired in the abovementioned processing in S22 with the arrangement of the data acquired in the abovementioned processing in S23, and determines a temporary virtual arrangement for migration if the cost due to the migration width of the data is equal to or less than a predetermined threshold (S24). The rearrangement location determining unit 24 then checks the data capacity of the temporary virtual arrangement and erases a capacity overflow as occasion calls (S25).

The rearrangement location determining unit 24 determines migration data based on a difference between the physical arrangement finally acquired in the processing in S25 and the current physical arrangement (S26). Next, the rearrangement executing unit 25 executes rearrangement of the data based on the migration data acquired in the processing in S26 (S27).

While a policy (threshold) for determining a physical tier for mainly storing the data is acquired and the data is arranged according to the policy in existing methods, such a policy evaluates the tiers for arrangement based on an absolute value of the access frequency of the data. As a result, the creation of available regions and the relative arrangement of data is not possible in the conventional methods and there is a concern that little data may be arranged in the upper tier and data may be arranged excessively in the lower to intermediate tiers. Accordingly, in the present embodiment, accessibility is effectively improved by performing the abovementioned rearrangement processing.

(S07: New Creation Processing)

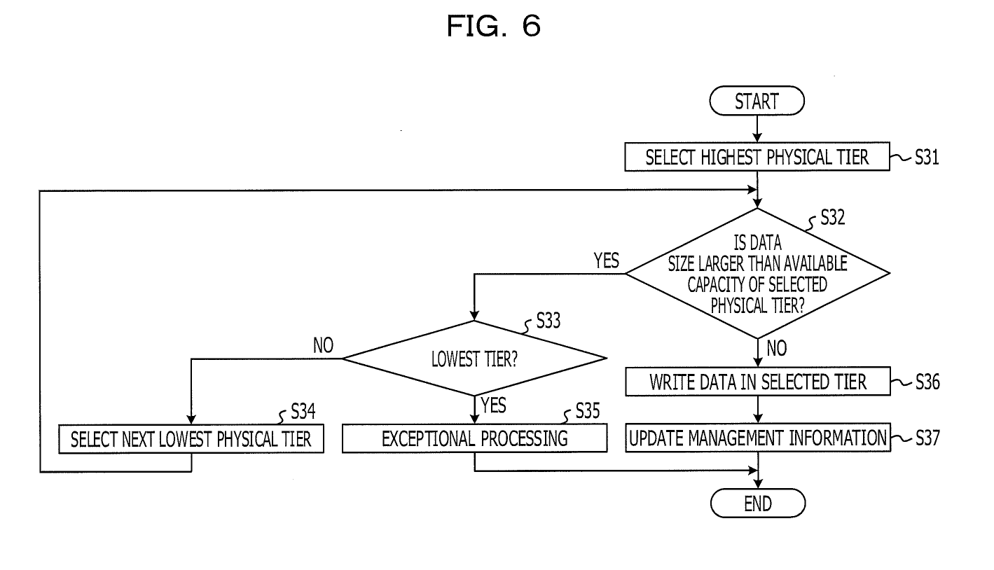

Next, the abovementioned new creation processing in S07 will be described with reference to a flow chart. FIG. 6 is a flow chart representing an example of new creation processing. In the example in FIG. 6, the new data writing evaluating unit 26 first selects the highest physical tier in the physical storage unit 27 (S31) and judges whether the size of new data is larger or not than the available capacity of the selected physical tier (S32).

If the data size is larger than the available capacity (S32: YES), the new data writing evaluating unit 26 judges whether the current tier is the lowest tier in the physical storage unit 27 (S33). If the current tier is not the lowest tier (S33: NO), the new data writing evaluating unit 26 selects the physical tier that is one tier lower (S34) and the routine returns to the processing in S32. Normally, the access speed in the lower tier of the physical tiers is slower than that of the upper tier but the capacity is often greater. As a result, one tier below the current tier is selected and the capacity is checked as in the processing in S34.

If the tier is the lowest tier (S33: YES), the new data writing evaluating unit 26 reports the fact of the capacity shortage, for example, to the user as exceptional processing (S35). If the selected physical tier is the lowest tier in the processing in S33, the exceptional processing is performed by the new data writing evaluating unit 26 since no physical tier exists below the tier and it is judged that the new data is not able to be written in a physical tier at this time.

If the data size in the processing in S32 is not larger than the available capacity of the selected physical tier (S32: NO), the new data writing evaluating unit 26 writes the new data in the selected tier (S36) and updates the management information (S37). The management information may include, but is not limited to, data ID, storage physical tiers, data size, access frequency and the like. According to this method, the new data is typically written in the highest tier in which data may be written. Since the new data is frequently accessed over a certain time period, access efficiency to the new data is improved and access efficiency to the entire storage device is improved.

(S21: Virtual Tier Creation Processing)

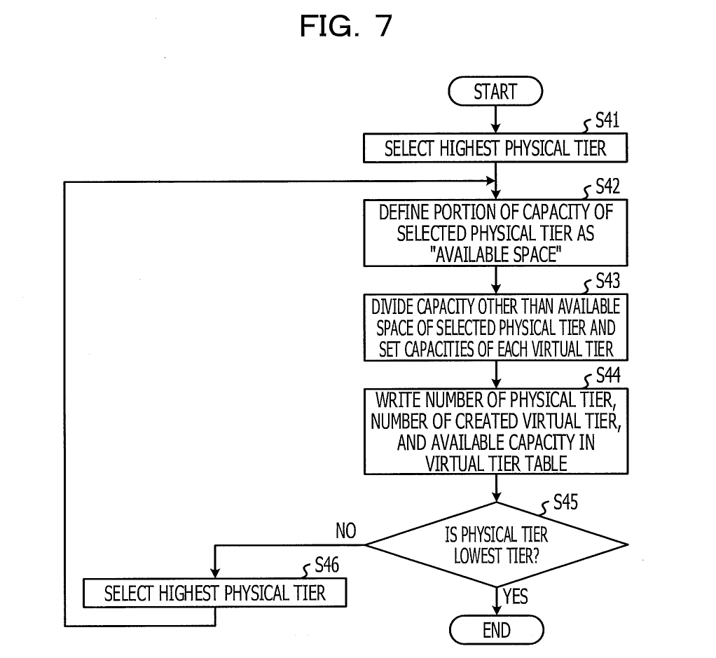

Next, the abovementioned processing (virtual tier creation processing) in S21 will be described with reference to a flow chart. FIG. 7 is a flow chart representing an example of virtual tier creation processing. The virtual tier creating unit 23 creates a virtual tier for examining the cost that occurs when migrating data. The virtual tier creating unit 23 keeps a portion of the physical tiers as an available region when creating the virtual tier and writes all the created virtual tier in a virtual tier table except for the kept capacity.

In the example in FIG. 7, the virtual tier creating unit 23 selects the highest physical tier (S41) and defines a portion of the capacity of the selected physical tier as “available space” that is not allocated to the virtual tiers (S42).

Next, the virtual tier creating unit 23 divides the capacity other than the available space and sets the capacities of each of the virtual tiers (S43) and then writes a number for identifying the physical tier and desired information such as the created number of the virtual tier and the available capacity and the like in a predetermined virtual tier table (S44).

Next, the virtual tier creating unit 23 judges whether the physical tier is the lowest tier (S45), and if the physical tier is not the lowest tier (S45: NO), the virtual tier creating unit 23 selects the physical tier below the current tier (S46) and the routine returns to the processing in S42. As a result, the creation of the abovementioned virtual tiers is performed for all of the physical tiers.

If the virtual tier creating unit 23 judges that the physical tier is the lowest tier in the processing in S45 (S45: YES), the processing is finished.

(Physical Tier Table)

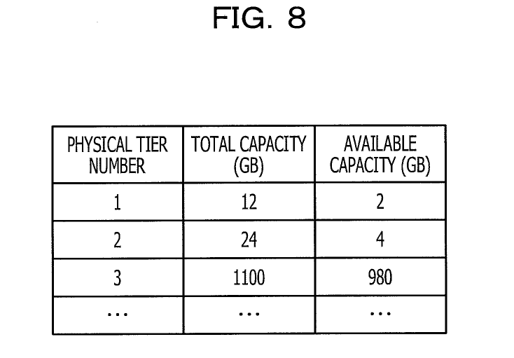

FIG. 8 is an example of a physical tier table. The items in the physical tier table illustrated in FIG. 8 include, but are not limited to, a “physical tier number,” a “total capacity (GB),” and an “available capacity (GB)” and the like.

The physical tier table is a table for managing storage regions of physical tiers set in the physical storage unit 27, and information related to one physical tier is stored in one column. The physical tiers are identified by numbers and the total capacity and the available capacity are managed for each physical tier. The information may be stored in the storage device 11 or in the management server 13.

In the example in FIG. 8, smaller tier numbers represent high physical tiers and the high physical tiers have faster access speeds than the lower physical tiers but have less data capacities. The physical tier table illustrated in FIG. 8 is previously created at a stage of preparation and the table is referred to and updated when creating the abovementioned virtual tiers, checking data capacities, and erasing capacity overflows.

(Virtual Tier Table)

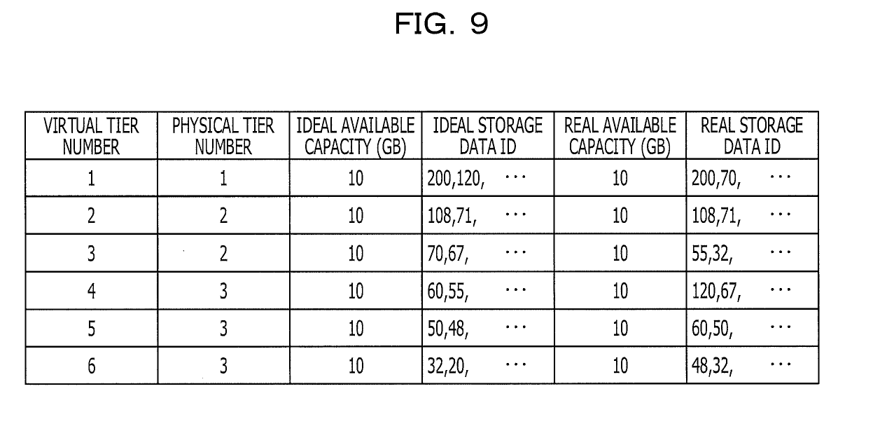

FIG. 9 is an example of a virtual tier table. Items in the virtual tier table illustrated in FIG. 9 include, but are not limited to, a “virtual tier number,” a “physical tier number,” an “ideal available capacity (GB),” an “ideal storage data ID,” a “real available capacity (GB),” and a “real storage data ID.”

The virtual tier number and the physical tier number represent identification information for identifying each of the virtual tiers and the physical tiers. Ideal storage data, real storage data, and the respective data IDs are managed in the virtual tier table for each virtual tier. One or more data IDs corresponding to an ideal available capacity and a real available capacity are stored for one virtual tier.

In the example in FIG. 9, information related to one virtual tier is stored in one column. The virtual tier table illustrated in FIG. 9 is created when creating the virtual tiers and is referred to and updated when allocating data to the ideal virtual tiers and the real virtual tiers.

(S22: Processing for Allocating Data to the Real Virtual Arrangement)

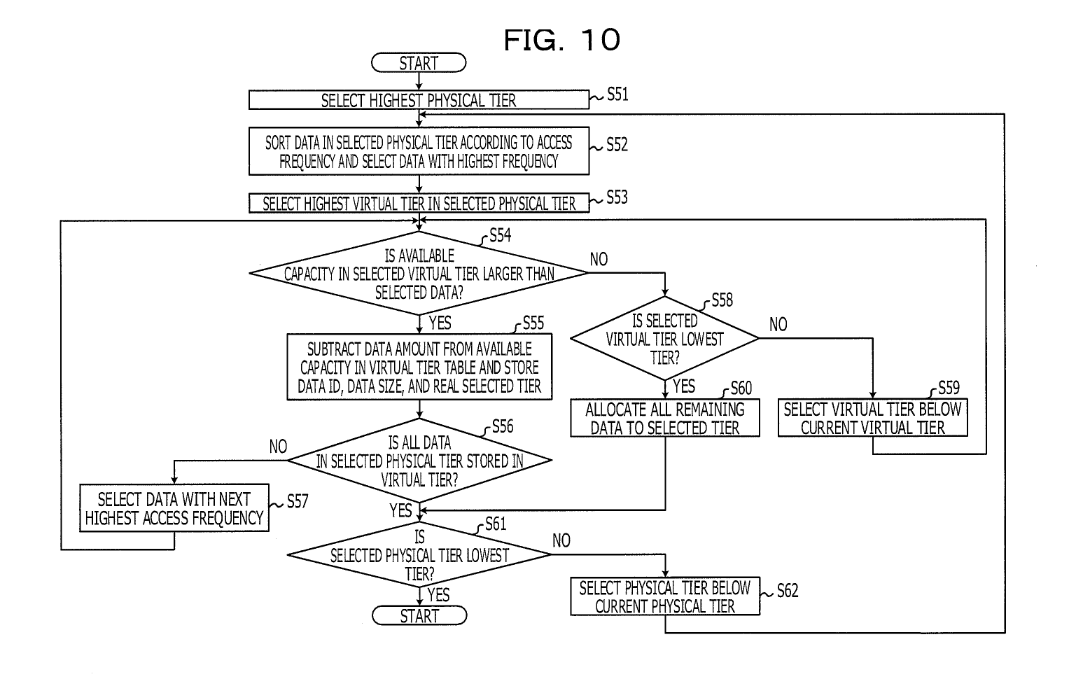

Next, the abovementioned processing (processing for allocating data to real virtual arrangement) in S22 will be described with reference to a flow chart. FIG. 10 is a flow chart representing an example of data allocation processing for allocation to a real virtual arrangement.

In the example in FIG. 10, the rearrangement location determining unit 24 selects the highest physical tier (S51), and sorts the data in the selected physical tier in descending order according to, for example, access frequency, and then selects the data with the highest access frequency (S52). The rearrangement location determining unit 24 selects the highest virtual tier in the selected physical tier (S53) and judges whether the available capacity of the selected virtual tier is larger than the data selected in the processing in S52 (S54).

If the available capacity in the selected virtual tier is larger than the selected data (S54: YES), the rearrangement location determining unit 24 subtracts the data amount of the selected data from the available capacity in the virtual tier table and stores the data ID, the data size, and the real selected tier (real virtual arrangement information) in a real virtual arrangement table (S55). The rearrangement location determining unit 24 may update the real stored data ID and the real available capacity in the virtual tier table in association with the stored data at this time.

Next, the rearrangement location determining unit 24 judges whether all the data in the selected physical tier is stored in the virtual tier (S56). If all the data is not stored in the virtual tier (S56: NO), the rearrangement location determining unit 24 selects the data with the next highest access frequency among the data in the selected physical tier (S57), and then the routine returns to the processing in S54.

If the available capacity of the selected virtual tier is not larger than the selected data in the processing in S54 (S54: NO), the rearrangement location determining unit 24 judges whether the selected virtual tier is the lowest tier (S58). If the selected virtual tier is not the lowest tier (S58: NO), the rearrangement location determining unit 24 selects the virtual tier below the current virtual tier (S59) and the routine returns to the processing in S54. If the selected virtual tier is the lowest tier in the processing in S58 (S58: YES), the rearrangement location determining unit 24 allocates all the remaining data to the selected tier (S60).

If all the data in the selected physical tier is stored in the virtual tier in the processing in S56 (S56: YES), or if the processing in S60 is finished, the rearrangement location determining unit 24 judges whether the selected physical tier is the lowest tier (S61). If the selected physical tier is not the lowest tier (S61: NO), the rearrangement location determining unit 24 selects the physical tier below the current physical tier (S62) and then the routine returns to the processing in S52. If the current physical tier in the lowest tier (S61: YES), the rearrangement location determining unit 24 finishes the processing.

In the example in FIG. 10, the data from the high tier is arranged in the virtual tier created from the physical tier containing the selected data. Specifically, the data is arranged in a relative manner in the virtual tier in order from the top within a range that does not exceed the physical tiers in the example in FIG. 10. If the access frequencies are the same, the rearrangement location determining unit 24 sorts the data according to the date and time of the last access or the data size and the like. The key for the sorting performed in the processing in S52 is not limited to the access frequency, and the data may be sorted according to, for example, the dates and times of the last access to the data. The real virtual tier in the management information is updated and the IDs of the stored data and the available capacities are updated in the virtual tier table.

(S23: Processing for Allocating Data to the Real Virtual Tiers)

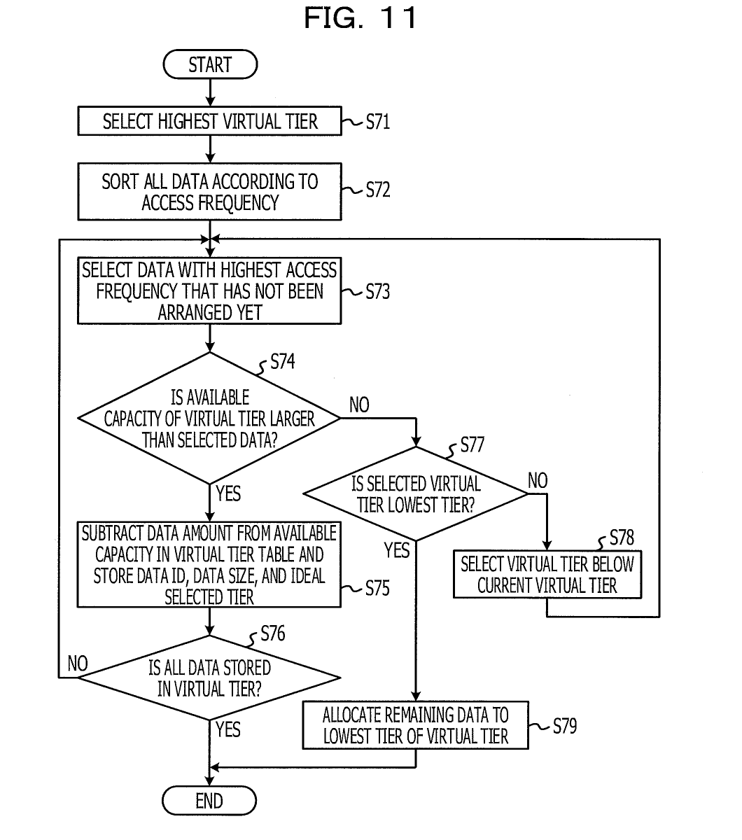

Next, the abovementioned processing (processing for allocating data to real virtual arrangement) in S23 will be described with reference to a flow chart. FIG. 11 illustrates an example of data allocation processing for allocation to an ideal virtual arrangement.

In the example in FIG. 11, the rearrangement location determining unit 24 selects the highest virtual tier (S71). The rearrangement location determining unit 24 then sorts all the data in descending order according to the access frequency (S72).

Next, the rearrangement location determining unit 24 selects the data having the highest access frequency that has not yet been arranged from the results acquired in the processing in S72 (S73), and judges whether the available capacity of the virtual tier is larger than the selected data (S74).

If the available capacity of the virtual tier is larger than the selected data (S74: YES), the rearrangement location determining unit 24 subtracts the data amount from the available capacity in the virtual tier table and stores the data ID, the data size, and the ideal selected tier (ideal virtual arrangement information) in an ideal virtual arrangement table (S75). The rearrangement location determining unit 24 may update the ideal stored data ID and the ideal available capacity in the virtual tier table in association with the stored data at this time.

Next, the rearrangement location determining unit 24 judges whether all the data is stored in the virtual tier (S76). If all the data is not stored in the virtual tier (S76: NO), the routine returns to the processing in S73.

If the available capacity of the virtual tier is not larger than the selected data in the processing in S74 (S74: NO), the rearrangement location determining unit 24 judges whether the selected virtual tier is the lowest tier (S77). If the selected virtual tier is not the lowest tier (S77: NO), the rearrangement location determining unit 24 selects the virtual tier below the current virtual tier (S78) and the routine returns to the processing in S73. If the selected virtual tier is the lowest tier in the processing in S77 (S77: YES), the rearrangement location determining unit 24 allocates the remaining data to the lowest tier of the virtual tiers (S79) and the processing is finished. If the rearrangement location determining unit 24 judges that all the data is stored in the virtual tier in the processing in S76 (S76: YES), the processing is finished.

In the example in FIG. 11, all the data is arranged in the ideal virtual tiers in order from the highest tier. Specifically, the data is arranged in a relative manner in the virtual tiers in order from the top across the physical tiers in the example in FIG. 11. If data with the same access frequencies is present, the rearrangement location determining unit 24 sorts the data according to the date and time of the last access or the data size and the like. The key for the sorting performed in the processing in S72 is not limited to the access frequency, and the data may be sorted according to, for example, the dates and times of the last access to that data. The ideal virtual tiers in the management information are updated and the IDs of the stored data and the available capacities are updated in the virtual tier table.

(S24: Method for Determining Temporary Virtual Arrangement)

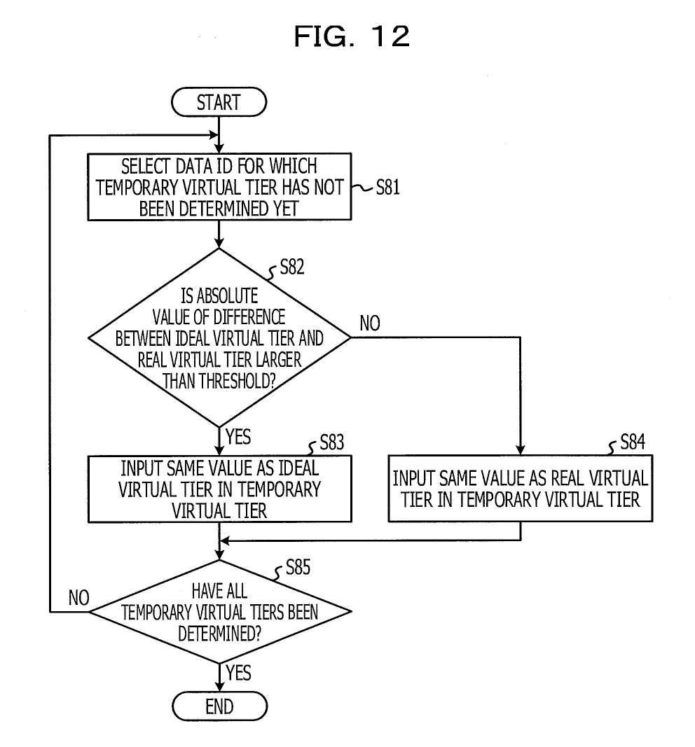

Next, the abovementioned processing (temporary virtual arrangement determination processing) in S24 will be described with reference to a flow chart. FIG. 12 is a flow chart representing an example of a determination method for a temporary virtual arrangement. In the example in FIG. 12, the rearrangement location determining unit 24 selects a data ID for which a temporary virtual tier is undetermined (S81). While the judgment as to whether the temporary virtual tier has been determined or not may be made according to, for example, whether a “temporary virtual tier” column included in a temporary virtual arrangement table is empty or not, the determination method is not limited as such.

The rearrangement location determining unit 24 then judges whether an absolute value of a difference between the ideal virtual tier and the real virtual tier of the selected ID is larger than a predetermined threshold (S82). If the absolute value of the difference is larger than the threshold (S82: YES), the rearrangement location determining unit 24 inputs the same value as the ideal virtual tier into the temporary virtual tier (S83). If the absolute value of the difference is not larger in the processing in S82 (S82: NO), the rearrangement location determining unit 24 inputs the same value as the real virtual tier in the temporary virtual tier as a low effect due to the migration of the data (S84).

Next, the rearrangement location determining unit 24 judges whether all of the temporary virtual arrangements have been determined (S85). If not all of the temporary virtual arrangements have been determined (S85: NO), the routine returns to the processing in S81. If all the temporary virtual arrangements have been determined (S85: YES), the rearrangement location determining unit 24 finishes the processing.

(Virtual Arrangement Table)

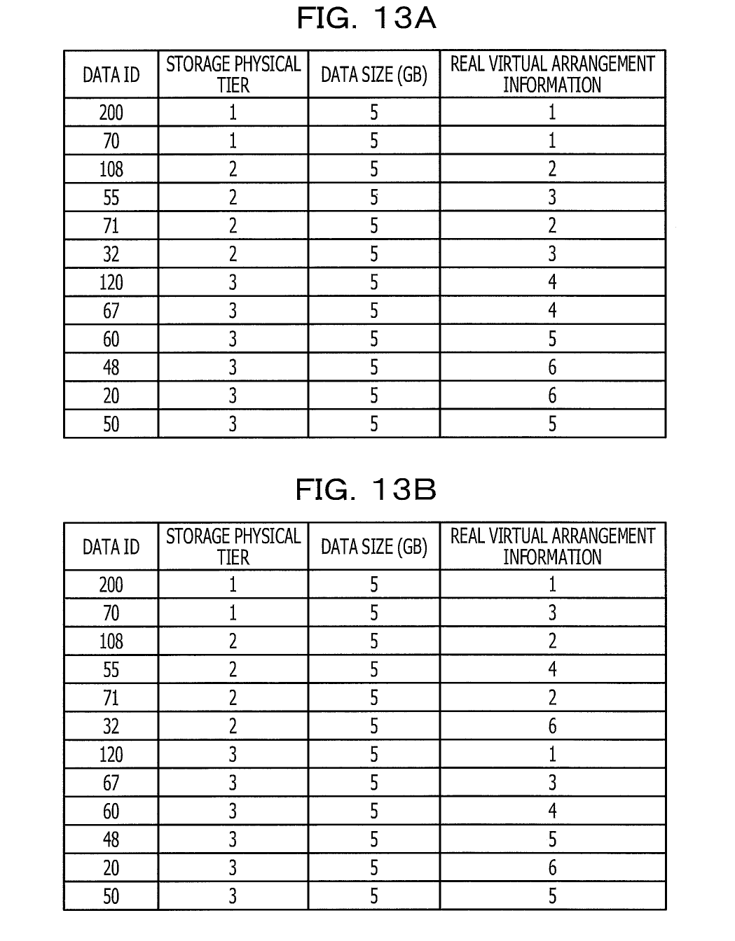

FIG. 13A is an example of a real virtual arrangement table. FIG. 13B is an example of an ideal virtual arrangement table.

The items in the real virtual arrangement table illustrated in FIG. 13A include, but are not limited to, a “data ID,” a “storage physical tier,” a “data size (GB),” and “real virtual arrangement information.” The real virtual arrangement table illustrated in FIG. 13A is created based on the abovementioned processing for allocating data to the real virtual arrangement described in FIG. 10.

The items in the ideal virtual arrangement table illustrated in FIG. 13B include, but are not limited to, a “data ID,” a “storage physical tier,” a “data size (GB),” and “ideal virtual arrangement information.” The ideal virtual arrangement table illustrated in FIG. 13B is created based on the abovementioned processing for allocating data to the ideal virtual arrangement illustrated in FIG. 11.

In the present embodiment, the tiers of the real virtual arrangement information in the real virtual arrangement table illustrated in FIG. 13A are compared with the tiers of the ideal virtual arrangement information in the ideal virtual arrangement table illustrated in FIG. 13B, and different portions are extracted and rearrangement positions are determined based on the extracted information to perform rearrangement to the determined rearrangement positions. In the present embodiment, when data is arranged in different tiers due to the rearrangement, the rearrangement is performed if the absolute value of the migration width exceeds a predetermined threshold, and the migration (rearrangement) is not performed if the absolute value of the migration width is equal to or less than the threshold.

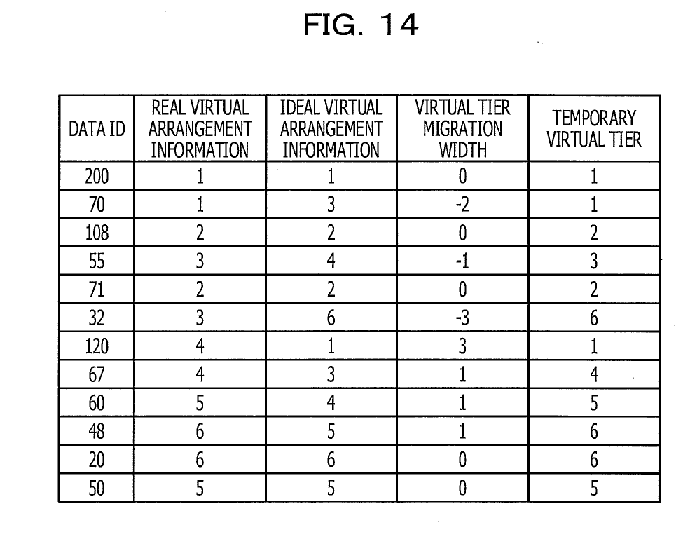

FIG. 14 is an example of a temporary virtual arrangement table. The items of the temporary virtual arrangement table illustrated in FIG. 14 include, but are not limited to, a “data ID,” “real virtual arrangement information,” “ideal virtual arrangement information,” a “virtual tier migration width,” and a “temporary virtual tier.”

The real virtual arrangement information illustrated in FIG. 14 is information acquired from the real virtual arrangement table in FIG. 13A. The ideal virtual arrangement information illustrated in FIG. 14 is information acquired from the ideal virtual arrangement table in FIG. 13B. Differential information (real virtual arrangement information—ideal virtual arrangement information) between the real virtual arrangement information and the ideal virtual arrangement information is stored in the virtual tier migration width illustrated in FIG. 14. The migration width may be absolute value information.

If, for example, the migration width is set so that three or more data are migrated to the ideal virtual arrangement, the data having data IDs “32” and “120” in the example in FIG. 14 are to be migrated since the migration widths (absolute values) are three or greater. Therefore, the ideal virtual arrangement values for the data having the data IDs “32” and “120” are set as temporary virtual arrangements, and the all the real virtual arrangement values of the data of the other data IDs are input in the temporary virtual arrangements. In the present embodiment, migration between a certain number of tiers or more is performed since the effect of the migration is high, and migration between less than the certain number of tiers is not performed since the effect of the migration is low and there will be a load on the system due to the migration.

The migration width is not necessarily an absolute value and the migration width may be managed using minus symbols as illustrated in FIG. 14. In this case, upper limit and lower limit thresholds may be provided. For example, without being limiting, the upper limit threshold may be two or more while the lower limit threshold may be negative five or less. As a result, migration to the upper tier may be prioritized and migration to the lower tier may be restricted.

(Detailed Example of Virtual Arrangements)

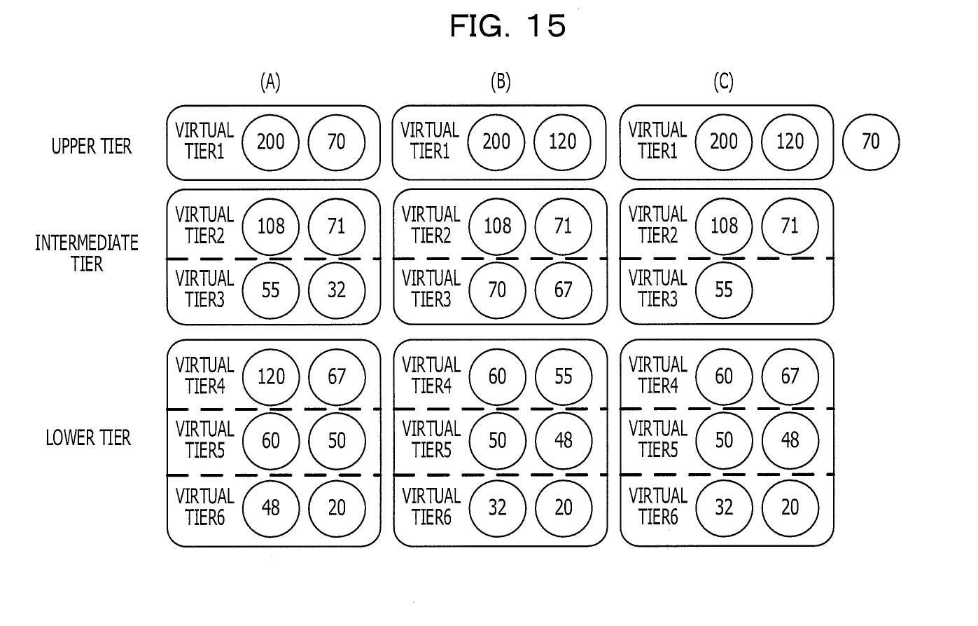

FIG. 15 illustrates detailed examples of virtual arrangements. (A) in FIG. 15 is an example of a real virtual arrangement, (B) in FIG. 15 is an example of an ideal virtual arrangement, and (C) in FIG. 15 is an example of a temporary virtual arrangement. In the examples in FIG. 15, the three tiers of the physical tier (storage region) are an upper tier, an intermediate tier, and a lower tier, and the relationship between access speeds of the tiers is “upper tier>intermediate tier>lower tier.”

In the examples in FIG. 15, the upper tier has one virtual tier (virtual tier 1), the intermediate tier has two tiers (virtual tiers 2, 3), and the lower tier has three virtual tiers (virtual tiers 4 to 6), although the number of tiers is not limited as such.

The method of dividing the virtual tiers from the physical tiers includes, for example, dividing by a certain capacity (e.g., per 10 GB), or dividing all the physical tiers into equal divisions (e.g., divide each physical tier into three divisions), but the division method is not limited as such.

While the numbers inside the circles illustrated in FIG. 15 represent data IDs, in order to simplify explanation, the numbers will represent access frequencies.

In the present embodiment, at least one virtual tier is set for each tier and real virtual tiers ((A) in FIG. 15) are allocated with respect to actually stored data using the set virtual tiers. The ideal virtual tiers ((B) in FIG. 15) are allocated in the present embodiment according to the sorted order based on a certain condition such as access frequency and the like. The migration of data in the present embodiment is determined based on the size of the migration width between the virtual tiers when the data is changed from a real virtual tier ((A) in FIG. 15) state to an ideal virtual tier ((B) in FIG. 15) state, and the temporary virtual tiers are set based on the result of the determination ((C) in FIG. 15).

(S25: Data Capacity Check Processing)

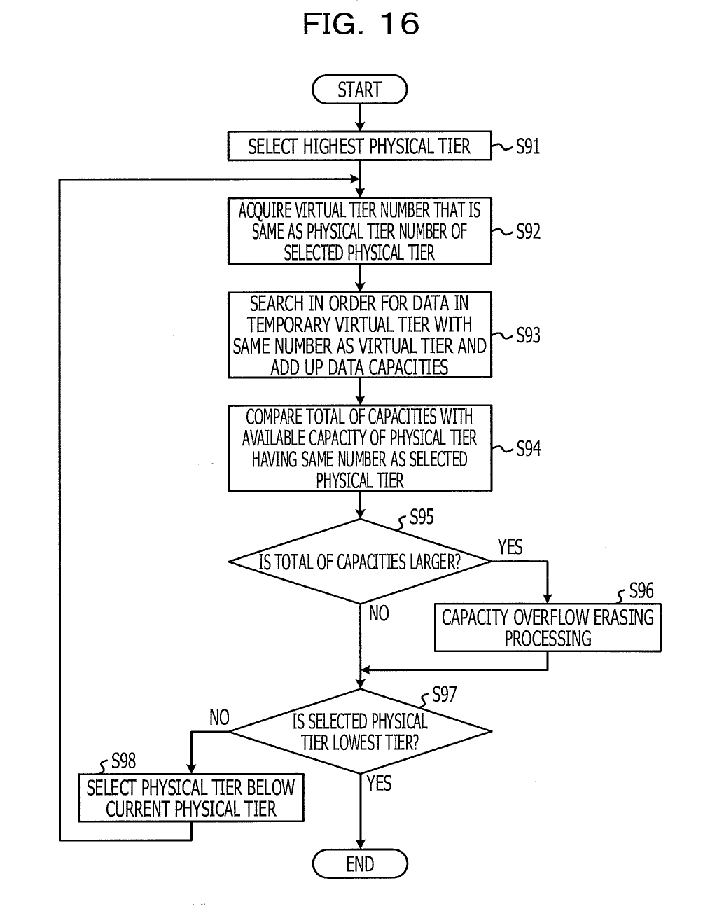

Next, the abovementioned processing (data capacity check processing) in S25 will be described with reference to a flow chart. FIG. 16 is a flow chart representing an example of check processing to check data capacity. In the example in FIG. 16, the rearrangement location determining unit 24 selects the highest physical tier (S91), and acquires, for example, a virtual tier number that is the same as the physical tier number of the selected physical tier from the virtual tier table (S92).

The rearrangement location determining unit 24 then searches in order for the data having the same temporary virtual tier number as the virtual tier number acquired from, for example, the temporary virtual arrangement table, and then adds up the data capacities (data sizes) (S93). The data capacities may be acquired from, but not limited to, for example, the real virtual arrangement table or from the ideal virtual arrangement table.

The rearrangement location determining unit 24 then compares the available capacity of the physical tier having the same number as that of the selected physical tier with the total of the capacities (S94), and judges if the total of the capacities is larger than the available capacity of the physical tier number (S95). If the total of the capacities is larger than the available capacity of the physical tier number (S95: YES), then the rearrangement location determining unit 24 performs capacity overflow erasing processing (S96). If the total of the capacities is not larger than the physical tier number (S95: NO), or if the processing in S96 is finished, the rearrangement location determining unit 24 judges whether the selected physical tier is the lowest tier (S97). If the selected physical tier is not the lowest tier (S97: NO), the rearrangement location determining unit 24 selects the physical tier below the current physical tier (S98), and the routine returns to the processing in S92. If the selected tier is the lowest tier (S97: YES), the processing is finished.

When determining the temporary virtual tiers, the total amount of data in a certain tier may surpass the physical capacity of that tier since it is determined that the migration of data is not to be performed. However in the data capacity check processing, the physical tiers are selected from the highest tier as described above and the total amount of the data arranged in the temporary virtual tier created based on the selected tier is calculated. If the total amount does not exceed the physical capacity, the processing advances to the next tier below, and the capacity overflow erasing processing in S96 is executed if the total amount exceeds the physical capacity.

(S96: Capacity Overflow Erasing Processing)

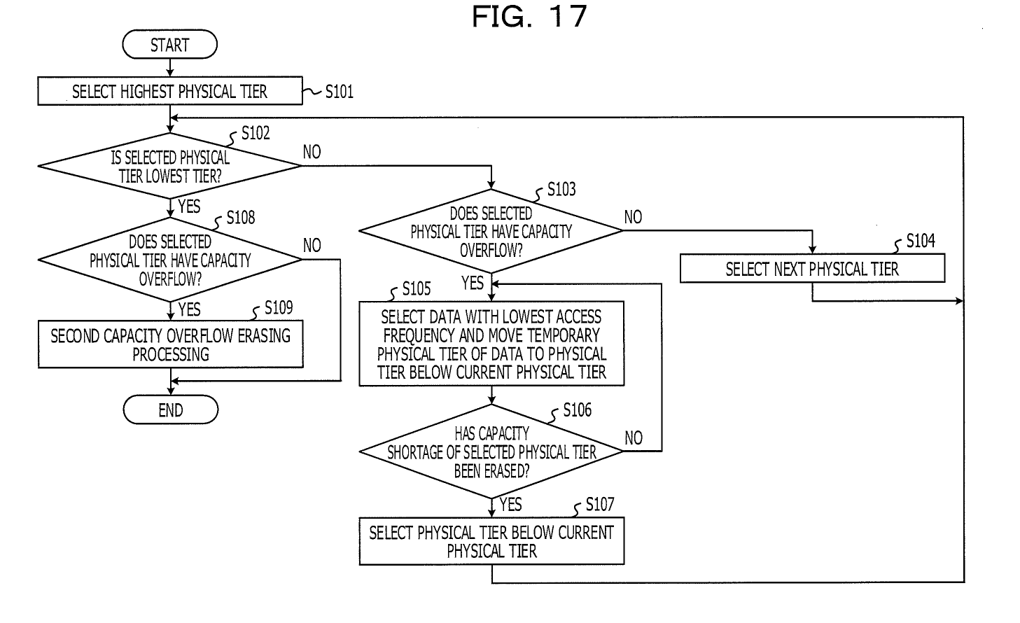

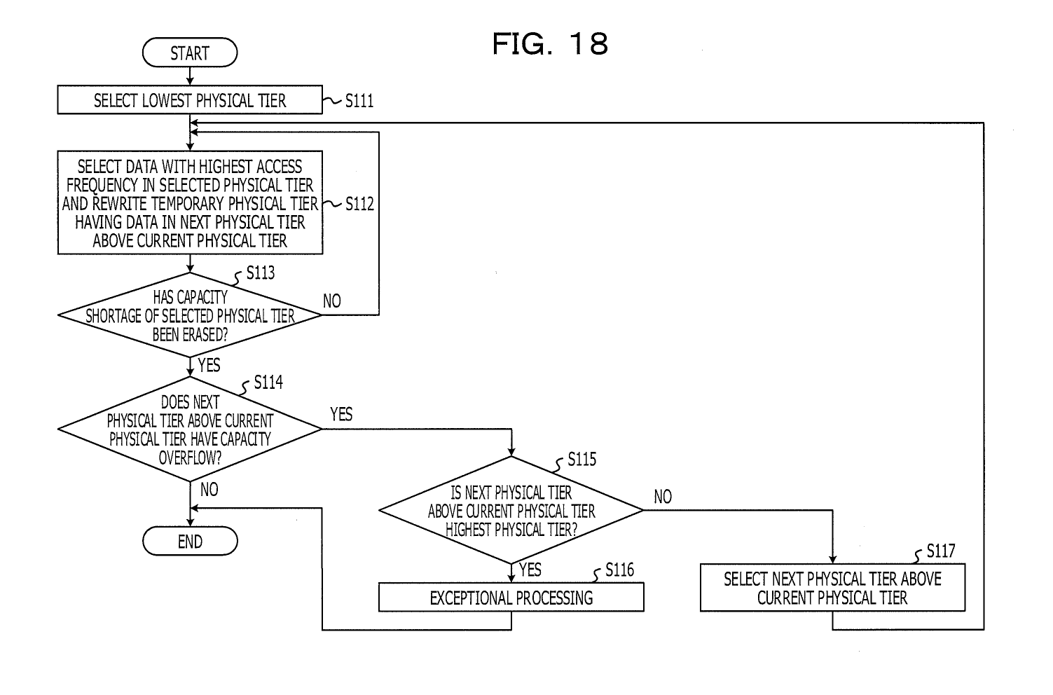

Next, the abovementioned processing (capacity overflow erasing processing) in S96 will be described with reference to a flow chart. FIGS. 17 and 18 illustrate a flow chart representing an example of capacity overflow erasing processing. In the following explanation, the processing illustrated in FIG. 17 is an example of a first capacity overflow erasing processing and the processing illustrated in FIG. 18 is an example of a second capacity overflow erasing processing.

The rearrangement location determining unit 24 in the example illustrated in FIG. 17 selects the highest physical tier (S101) and judges whether the selected physical tier is the lowest tier (S102). If the selected physical tier is not the lowest tier (S102: NO), the rearrangement location determining unit 24 judges whether the selected physical tier has a capacity overflow (S103). If the selected physical tier does not have a capacity overflow (S103: NO), the rearrangement location determining unit 24 selects the next physical tier below the current physical tier (S104) and the routine returns to the processing in S102.

If the selected physical tier has a capacity overflow in the processing in S103 (S103: YES), the rearrangement location determining unit 24 selects the data with the lowest access frequency in the currently selected physical tier and moves the temporary physical tier of the data to the physical tier below the current physical tier (S105). While the data of the temporary virtual tier may be listed for each physical tier and sorted by access frequency, the present embodiment is not limited as such.

Next, the rearrangement location determining unit 24 judges whether the capacity shortage has been erased from the selected physical tier (S106). If the capacity shortage has not been erased (S106: NO), the routine returns to S105. If the capacity shortage has been erased in the processing in S106 (S106: YES), the rearrangement location determining unit 24 selects the physical tier below the currently selected physical tier (S107) and the routine returns to the processing in S102.

If the selected physical tier is the lowest tier in the processing in S102 (S012: YES), the rearrangement location determining unit 24 judges whether the selected physical tier has a capacity overflow (S108). If the selected physical tier has a capacity overflow (S108: YES), the second capacity erasing processing is performed as illustrated in FIG. 18 (S109).

If the selected physical tier does not have a capacity overflow (S108: NO), or after the processing in S109, the processing is finished.

The following is an explanation of the second capacity overflow erasing processing illustrated in FIG. 18. The rearrangement location determining unit 24 selects the lowest physical tier (S111), and selects the data with the highest access frequency in the selected physical tier and rewrites the temporary physical tier of the data in the next physical tier above the current physical tier (S112). While the data of the temporary virtual tier may be listed for each physical tier and sorted by access frequency, the present embodiment is not limited as such.

Next, the rearrangement location determining unit 24 judges whether the capacity shortage has been erased from the selected physical tier (S113). If the capacity shortage has not been erased from the selected physical tier (S113: NO), the routine returns to S112. If the capacity shortage of the selected physical tier has been erased (S113: YES), the rearrangement location determining unit 24 judges whether the next physical tier above the selected physical tier has a capacity shortage (S114). If the capacity shortage of the next physical tier above the selected physical tier has been erased (S114: YES), the rearrangement location determining unit 24 judges whether the next physical tier above the selected physical tier is the highest physical tier (S115). If the next physical tier above the selected physical tier is the highest physical tier (S115: YES), the rearrangement location determining unit 24 further judges that the capacity overflow may not be erased at this time since no physical tier is present thereabove, and reports the fact of the capacity overflow to the user as exceptional processing (S116), and then the routine is finished.

If the next physical tier above the selected physical tier is not the highest physical tier in the processing in S115 (S115: NO), the rearrangement location determining unit 24 selects the next physical tier above the currently selected physical tier (S117) and the routine returns to the processing in S112. The information of data migrated due to the capacity overflow erasing processing illustrated in FIGS. 17 and 18 is stored, for example, as storage physical tiers.

(View for Describing Capacity Overflow Erasing Processing)

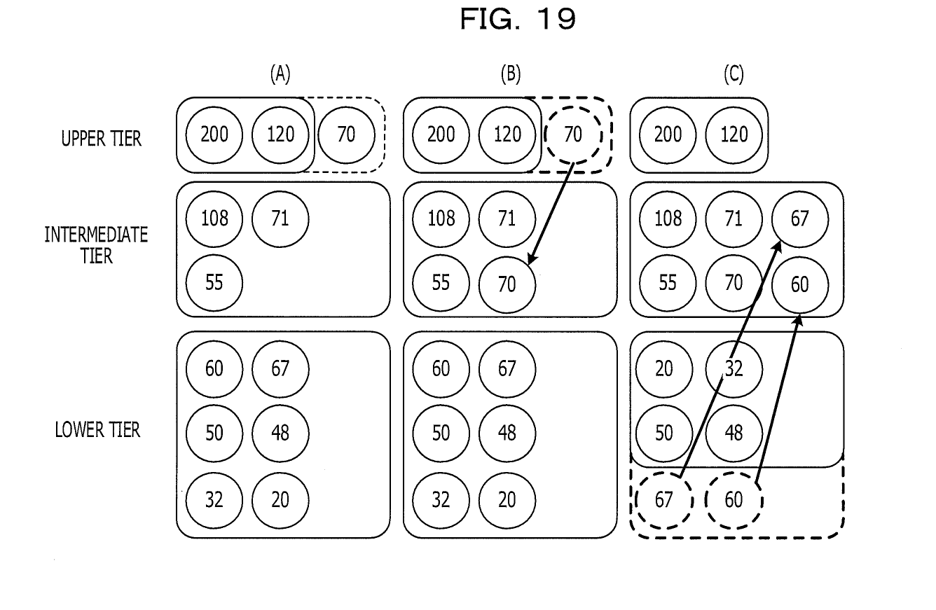

FIG. 19 is a view for describing capacity overflow erasing processing. While the numbers inside the circles illustrated in FIG. 19 represent data IDs, in order to simplify explanation, the numbers will represent access frequencies. (A) in FIG. 19 corresponds to the abovementioned temporary virtual tier in (C) in FIG. 15.

The capacity overflow erasing processing involves selecting one physical tier from the state illustrated in (A) in FIG. 19, and checking whether the total capacity of the data temporarily arranged in the physical tier exceeds the total capacity of the physical tier. If the total capacity of the data exceeds the total capacity of the physical tier, the data with the lowest access frequency is selected from the data in the selected physical tier.

In the example in (A) in FIG. 19, the total capacity of the data having the data IDs “200,” “120,” and “70” exceeds the total capacity of the upper tier. Therefore, the rearrangement location determining unit 24 selects the data ID “70” that represents the data having the lowest access frequency among the data in the upper tier. The rearrangement location determining unit 24 then migrates the selected data to the next physical tier below the current physical tier. In the example in (B) in FIG. 19, the data having the data ID “70” is migrated to the intermediate tier.

The rearrangement location determining unit 24 erases the capacity overflow of the tier selected in the abovementioned processing. If the capacity overflow is erased, the rearrangement location determining unit 24 checks whether the next tier (intermediate tier in the example (A) in FIG. 19) below the current tier has a capacity overflow or not.

If the lowest tier does not have a capacity overflow, the rearrangement location determining unit 24 finishes the processing, and if the lowest tier has a capacity overflow, the rearrangement location determining unit 24 performs the abovementioned second capacity overflow erasing processing illustrated in FIG. 18.

If, for example, the lower tier has a capacity overflow, the second capacity overflow erasing processing involves selecting the data having the highest access frequency therein and migrating the data ID to the next physical tier above the current physical tier. The above processing is performed until the capacity overflow of the lower tier is erased. In the example in (C) in FIG. 19, the data IDs “67” and “60” are migrated to the intermediate tier.

The rearrangement location determining unit 24 then selects the next physical tier (intermediate tier in the example in FIG. 19) above the current physical tier and checks whether the selected tier has a capacity overflow. If the selected tier does not have a capacity overflow, the rearrangement location determining unit 24 finishes the second capacity overflow erasing processing.

If the intermediate tier has a capacity overflow, the rearrangement location determining unit 24 then selects the data (e.g., data ID “108”) having the highest access frequency in that tier and migrates the data ID to the next physical tier (upper tier in the example in FIG. 19) above the selected physical tier. The rearrangement location determining unit 24 performs the above processing until the capacity overflow of the intermediate tier is erased. If the upper tier has a capacity overflow, the rearrangement location determining unit 24 performs exceptional processing (e.g., reporting an error message) as a capacity overflow.

(S26: Migration Data Determining Processing)

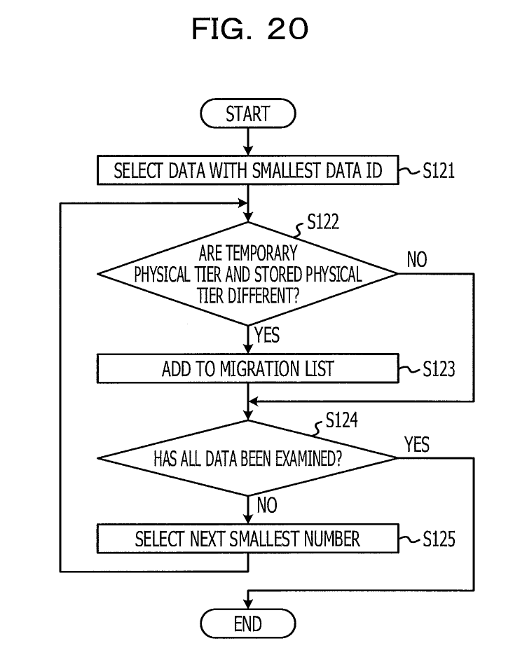

Next, the abovementioned processing (migration data determining processing) in S26 will be described with reference to a flow chart. FIG. 20 is a flow chart representing an example of determination processing for determining migration data.

In the example illustrated in FIG. 20, the rearrangement location determining unit 24 selects the data having the smallest data ID from, for example, the temporary virtual arrangement table (S121) and judges whether there is a difference between the temporary physical tier represented in the temporary virtual arrangement table and the stored physical tier represented in, for example, the real virtual arrangement table (S122). If the temporary physical tier and the stored physical tier are different (S122: YES), the rearrangement location determining unit 24 adds the contents of the stored physical tier corresponding to the selected data ID to the migration list (S123).

If the temporary physical tier and the stored physical tier are not different in the processing in S122 (S122: NO), or after the processing in S123, the rearrangement location determining unit 24 judges whether all the data has been examined (S124). If all the data has not been examined (S124: NO), the rearrangement location determining unit 24 selects the data ID with the next smallest number (S125) and the routine returns to the processing in S122. If all the data has been examined (S124: YES), the rearrangement location determining unit 24 finishes the processing.

(Example of Migration List)

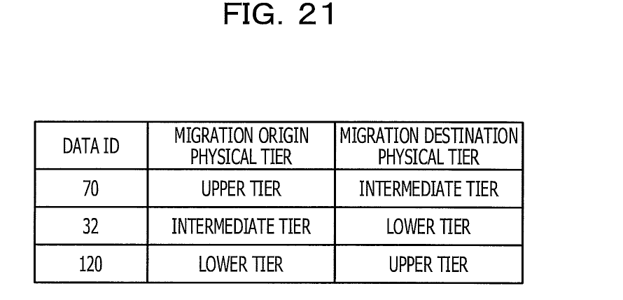

FIG. 21 is an example of a migration list. The items in the migration list illustrated in FIG. 21 include, but are not limited to, a “data ID,” a “migration origin physical tier,” and a “migration destination physical tier” and the like.

While physical tiers (e.g., upper tier, intermediate tier, lower tier) are stored in the migration origin physical tier and the migration destination physical tier in the migration list illustrated in FIG. 21, the present embodiment is not limited as such and numbers (physical tier numbers) for identifying the physical tiers for example may be stored.

The data rearrangement processing by the rearrangement executing unit 25 is performed based on the information in the migration list as illustrated in FIG. 21 in the present embodiment. As a result, suitable data migration to the physical storage unit 27 is realized and the accessibility is effectively improved.

According to the abovementioned present embodiment, the load due to the data rearrangement is reduced and accessibility may be effectively improved. Specifically, in the present embodiment, physical tiers are subdivided and virtual tiers are created, and an ideal arrangement and a real arrangement of relatively evaluated data are created in the created virtual tier and compared, and the migration of data having a low effect due to the migration is canceled.

In this case in the present embodiment, an available region is secured and the introductions of an upper tier priority arrangement due to the relative evaluation and a virtual tier are performed. The securing of an available region involves making a space available for inserting when newly creating data by creating a region in which data has not been allocated yet in an upper tier when rearranging the data. As a result, when writing due to new data occurs, the new data may be written in the upper tier, which is an available region with disks that allow high-speed access, and consequently high accessibility is realized.

In the introduction of the upper tier priority arrangement due to the relative evaluation, the data is evaluated in a relative manner based on a certain index value without performing an absolute evaluation during the rearrangement, and the data is arranged in order from the upper tier. For example, the data is sorted in a descending order based on the access frequency and the data is arranged in order from the upper tier. As a result, in the present embodiment, higher accessibility is realized by arranging the data with a high access frequency in order from the upper tier than when the data is arranged according to an absolute evaluation.

Moreover, with the introduction of the virtual tier, a simulation of migration cost is made possible due to the introduction of the virtual tier and thus a migration with a low effect may be extracted. For example, in the present embodiment, an ideal data arrangement and a real data arrangement are created in a virtual tier by using a virtual tier further divided from a physical tier. The two arrangements are compared in the present embodiment to calculate a migration cost with the use of an index value and a determination is made as to whether the migration is possible or not by providing a threshold corresponding to the migration cost calculation.

The migration cost in the present embodiment is calculated using, for example, a migration width between virtual tiers, data sizes (evaluation that stipulates that it is difficult to migrate data with a large data size), or the time of the last migration (evaluation that stipulates that it is harder to migrate data that has been migrated recently). As a result, the suitability of a data migration may be evaluated in more detail than in conventional methods since the migration is not understood as a migration between physical tiers but as a migration between virtual tiers. Therefore, small changes may all be extracted as less effective migrations due to the relative evaluation and the migration of data between tiers may be canceled.

By providing a threshold or a judgment standard, the suitability of a migration may be judged based on an evaluation result. Wasteful migrations may be reduced thus enabling a reduction in the number of accesses to the storage device and improving accessibility to the entire storage device.

While the above embodiment has been discussed in detail, the embodiment is not limited in particular and various modifications and changes may be made in addition to the above embodiment without departing from the scope of the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of arranging data in a stratified storage region, the method comprising:
acquiring an index value related to data stored in the stratified storage region based on a predetermined rearrangement condition; and
determining, based on the index value, data to be migrated from the data stored in the stratified storage region.

2. The method according to claim 1, wherein
the rearrangement condition includes an access frequency of the data; and
wherein the acquiring acquires the index value based on relative access frequencies between the data stored in the stratified storage region.

3. The method according to claim 1, further comprising:
setting a virtual tier with respect to the stratified storage region;
wherein, the acquiring acquires the index value based on a first result in which the data stored in the stratified storage region is allocated to the virtual tier based on the tier of the stratified storage region in which the data is stored, and a second result in which the data is allocated to the virtual tier based on a predetermined condition.

4. The method according to claim 3, wherein
the index value is a difference in tiers between a first tier in the virtual tier corresponding to the first result and a second tier in the virtual tier corresponding to the second result.

5. The method according to claim 4, wherein
the determining determines that data stored in the stratified storage region for which the difference in tiers exceeds a threshold is the data to be migrated.

6. The method according to claim 1, further comprising:
determining a virtual arrangement of data stored in the stratified storage region based on the index value; and
erasing a certain state, wherein the certain state is when the data capacity of the virtual arrangement exceeds the capacity of the stratified storage region.

7. The method according to claim 1, further comprising:
inserting newly created data in an upper tier storage region in the stratified storage region.

8. An information processing apparatus comprising:
a memory; and
a processor coupled to the memory and configured to:
acquire an index value related to data stored in the stratified storage region based on a predetermined rearrangement condition, and
determine, based on the index value, data to be migrated from the data stored in the stratified storage region.

9. The information processing apparatus according to claim 8, wherein
the rearrangement condition includes an access frequency of the data, and
wherein the processor is configured to acquire the index value based on relative access frequencies between the data stored in the stratified storage region.

10. The information processing apparatus according to claim 8, wherein the processor is configured to:
set a virtual tier with respect to the stratified storage region, and
acquire the index value based on a first result in which the data stored in the stratified storage region is allocated to the virtual tier based on the tier of the stratified storage region in which the data is stored, and a second result in which the data is allocated to the virtual tier based on a predetermined condition.

11. The information processing apparatus according to claim 10, wherein
the index value is a difference in tiers between a first tier in the virtual tier corresponding to the first result and a second tier in the virtual tier corresponding to the second result.

12. The information processing apparatus according to claim 11, wherein the processor is configured to:
determine that data stored in the stratified storage region for which the difference in tiers exceeds a threshold is the data to be migrated.

13. The information processing apparatus according to claim 8, wherein the processor is configured to:
determine a virtual arrangement of data stored in the stratified storage region based on the index value, and
erase a certain state, wherein the certain state is when the data capacity of the virtual arrangement exceeds the capacity of the stratified storage region.

14. The information processing apparatus according to claim 8, wherein the processor is configured to insert newly created data in an upper tier storage region in the stratified storage region.

15. A non-transitory recording medium storing a program for causing an information processing apparatus to execute a process, the process comprising:
acquiring an index value related to data stored in the stratified storage region based on a predetermined rearrangement condition; and
determining, based on the index value, data to be migrated from the data stored in the stratified storage region.

16. The non-transitory recording medium according to claim 15, wherein
the rearrangement condition includes an access frequency of the data; and
wherein the acquiring acquires the index value based on relative access frequencies between the data stored in the stratified storage region.

17. The non-transitory recording medium according to claim 15, wherein the process further comprising:
setting a virtual tier with respect to the stratified storage region;
wherein, the acquiring acquires the index value based on a first result in which the data stored in the stratified storage region is allocated to the virtual tier based on the tier of the stratified storage region in which the data is stored, and a second result in which the data is allocated to the virtual tier based on a predetermined condition.

18. The non-transitory recording medium according to claim 17, wherein
the index value is a difference in tiers between a first tier in the virtual tier corresponding to the first result and a second tier in the virtual tier corresponding to the second result.

19. The non-transitory recording medium according to claim 15, wherein the process further comprising:
determining a virtual arrangement of data stored in the stratified storage region based on the index value; and
erasing a certain state, wherein the certain state is when the data capacity of the virtual arrangement exceeds the capacity of the stratified storage region.

20. The non-transitory recording medium according to claim 15, wherein the process further comprising:
inserting newly created data in an upper tier storage region in the stratified storage region.
